(19) United States
(12) Patent Application Publication
(10) Pub. No.: US 2002/0015259 A1
(43) Pub. Date: Feb. 7, 2002

(54) Method for manufacturing a structure with curved surfaces

(76) Inventor: Munekazu Nishihara, Neyagawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 09/881,687

(22) Filed: Jun. 18, 2001

(30) Foreign Application Priority Data
Jun. 19, 2000 (JP) 2000-182426

(51) Int. Cl. G11B 5/147

(52) U.S. Cl. 360/126

(57) ABSTRACT

A structure used as an electronic device including a magnetic head, an optical device, or precision parts has a structure body. A thin film is formed on one surface of the structure body by sputtering. The structure body is curved by an inner stress in the thin film, thereby the one surface and the other surface opposite to the one surface being formed into curved surfaces.

### BACKGROUND OF THE INVENTION

The present invention relates to a method for manufacturing a structure with curved surfaces. The structure can be used as devices such as electronic devices including magnetic heads, optical devices, and precision parts. Specifically, the present invention relates to a method for manufacturing a structure with curved surfaces without causing changes of properties of the structure.

Recently, structures having a functional film such as a thin film are used more often as electronic devices in order to satisfy requirements for sophisticated functions and low cost as functional devices. The electronic device has large sensitivity to the process environment since its device structure using the functional film is constituted by lamination of particular materials at the level of atomic. Due to this sensitivity, avoiding damage of the device is needed when working such as shaping is performed at post-processes.

For example, in case of curved surface shaping typically performed in manufacturing of a thin film magnetic head, grinding such as lapping at post-process causes a problem that the properties and functions of the device considerably vary due to variation of shaping which arise at the grinding process.

Relating to this, specification of Japanese patent No. 2,552,068 discloses that curved surfaces of a structure is controlled by selective shaping which uses processes such as laser processes and sandblasting processes. Further, Japanese Laid-open Publication No. HEI 1-30,082 discloses that a curved surface is formed on a structure by forming a material layer of a different thermal expansion coefficient thereon under heating condition and subsequent cooling of the structure to a normal temperature.

With reference to FIGS. 6 and 7, above-mentioned examples of conventional processes for manufacturing a structure with curved surfaces will be described. In the first example shown in FIG. 6, by energy shaping of a structure 1 such as a laser or blasting 2, the structure 1 is shaped into a curved configuration. In the second example shown in FIG. 7, the structure 1 is arranged in a heat chamber 3 (refer to FIG. 7A) and a heat contraction material layer 4 is formed on the structure 1 under heating condition (refer to FIG. 7B). Then, the heat chamber 3 is cooled to a normal temperature, resulting in that the structure 1 is shaped into a curved configuration (refer to FIG. 7C).

However, since above-mentioned curved surface shaping processes of conventional art adopt the grinding processes such as lapping and blasting or the heat processes such as laser process and heating, there is a problem that, in case of a structure with sensitive device function, device properties of the structure are damaged and deteriorated, and a functional film thereof can not exert its intrinsic functions.

### SUMMARY OF THE INVENTION

The object of the invention is therefore to provide a method for manufacturing a structure with curved surfaces without using grinding processes and heat processes.

A first aspect of the invention provides a method for manufacturing a structure with curved surfaces comprising: providing a structure body; forming a thin film on one surface of the structure body by sputtering so that the structure body is curved by an inner stress generated in the thin film, thereby the one surface of the structure body and the other surface of the structure body are formed into the curved surfaces.

According to the first aspect of the invention, since the structure is manufactured without using grinding processes and heat processes, the structure with curved surfaces which fully exerts its own functions can be obtained without causing damages to device properties even if device functions of the structure is sensitive.

Thin film is preferably composed of a material having an atomic weight of not less than 40 and not more than 240. By using the material having the atomic weight within this range, the formed thin film has enough inner stress, resulting in that the structure can be surely formed so that it has surfaces of necessary curvatures.

Curvatures of the curved surfaces can be adjusted by a pressure during the formation of the thin film by sputtering. Specifically, by setting the pressure higher than a predetermined pressure, the other surface opposite to the one surface on which the thin film is formed becomes a convex curved surface, and by setting the pressure lower than the predetermined pressure, the one surface on which the thin film is formed becomes a convex curved surface.

Further, the formation of the thin film by sputtering is executed in an evacuated chamber, and curvatures of the surfaces can be adjusted by an initial pressure in the evacuated chamber before the formation of the thin film. Specifically, by setting the initial pressure higher than a predetermined pressure, the other surface opposite to the one surface on which the thin film is formed becomes a convex curved surface, and by setting the initial pressure lower than the predetermined pressure, the one surface on which the thin film is formed becomes a convex curved surface.

The formation of the thin film by sputtering is executed by appliance of a voltage to a target opposite to the structure body, and curvatures of the surfaces can be adjusted by the voltage applied to the target. Specifically, by setting the voltage higher than a predetermined voltage, the one surface on which the thin film is formed becomes a convex curved surface, and by setting the voltage lower than a predetermined voltage, the other surface opposite to the one surface on which the thin film is formed becomes a convex curved surface.

It is preferable that the structure body is cooled during the formation of the thin film. By this cooling, rise in temperature of the structure during the formation of the thin film can be prevented.

For instance, the structure body is an Al₂O₃-TiC substrate, a temperature of the structure body during sputtering is not less than 20° C. and not more than 50° C., a pressure in an evacuated chamber during sputtering is not less than 0.5 Pa and not more than 5.0 Pa, and the thin film is composed of tantalum (Ta) or Chromium (Cr).

A second aspect of the invention provides, a method for manufacturing a magnetic head, comprising: providing a magnetic head substrate with a single or a plurality of built-in devices; and forming a thin film on one surface of the magnetic head substrate by sputtering so that the magnetic head substrate is curved by an inner stress generated in the thin film, thereby the one surface and the other surface of the magnetic head substrate are formed into curved surfaces, convex one of which acts as a head surface. The magnetic head substrate may be cut for separating it into a plurality of magnetic heads after the formation of the thin film.

A third aspect of the invention provides, a structure with curved surfaces comprising: a structure body; and a thin film formed on one surface of the structure body by sputtering, wherein the structure body is curved by an inner stress of the thin film, thereby the one surface of the structure body and the other surface of the structure body opposite to the one surface are formed into the curved surfaces.

A fourth aspect of the invention provides a magnetic head comprising: a magnetic head substrate with a single or a plurality of built-in devices; and a thin film formed on one surface of the magnetic head substrate by sputtering, wherein the magnetic head substrate is curved by an inner stress of the thin film, thereby the one surface of the magnetic head substrate or the other surface of the magnetic head substrate opposite to the one surface is formed into a convex curved surface acts as a head surface.

### BRIEF DESCRIPTION OF THE DRAWINGS

Further objects and advantages of the present invention will become clear from the following description taking in conjunction with the preferred embodiments thereof with reference to the accompanying drawings, in which:

FIG. 1 is a schematic configuration view of a sputtering apparatus employed in a method for manufacturing a structure with curved surfaces according to an embodiment of the invention;

FIG. 2A is a perspective view of a magnetic head substrate before formation of a thin film;

FIG. 2B is a perspective view of the magnetic head substrate with the thin film;

FIG. 2C is a perspective view of the magnetic head substrate which is curved by an inner stress (tensile stress) of the thin film;

FIG. 2D is a perspective view showing a cutting process of the magnetic head substrate;

FIG. 3A is a sectional view taken along line III-III of FIG. 2A;

FIG. 3B is a sectional view taken along line III′-III′ of FIG. 2B;

FIG. 3C is a sectional view taken along line III′′-III′′ of FIG. 2C;

FIG. 4A is a perspective view of a magnetic head substrate before formation of a thin film;

FIG. 4B is a perspective view of the magnetic head substrate with a thin film;

FIG. 4C is a perspective view of the magnetic head substrate which is curved by an inner stress (compression stress) of the thin film;

FIG. 4D is a perspective view showing a cutting process of the magnetic head substrate;

FIG. 5A is a sectional view taken along line V-V of FIG. 4A;

FIG. 5B is a sectional view taken along line V′-V′ of FIG. 4B;

FIG. 5C is a sectional view taken along line V′′-V′′ of FIG. 4C;

FIG. 6 is a schematic explanation view illustrating a conventional manufacturing process of a structure with curved surfaces; and

FIGS. 7A through 7C are schematic explanation views illustrating another conventional manufacturing process of a structure with curved surfaces.

### DETAILED DESCRIPTION OF THE PREFERRED EMBODIMENTS

Preferred embodiments of a method for manufacturing a structure with curved surfaces according to the present invention will be described in detail with reference to drawings.

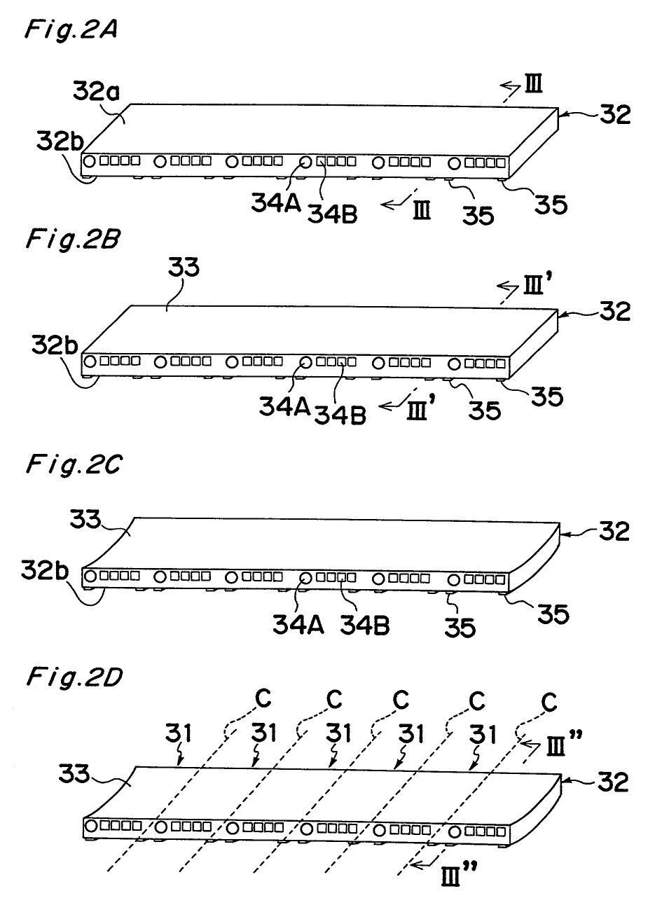

FIGS. 2D and 3C, and FIGS. 4D and 5C respectively show a magnetic head 31 which is a structure with curved surfaces according to the present invention. This magnetic head 31 comprises a structure body or a magnetic head substrate 32 and a thin film 33 formed on one surface 32a of the magnetic head substrate 32 by sputtering. The magnetic head substrate 32 is composed of Al₂O₃-TiC and has built-in devices 34A and 34B. The thin film 33 is composed of tantalum (Ta) or Chromium (Cr).

The magnetic head substrate 32 is curved by an inner stress of the thin film 33, thereby both the one surface 32a on which the thin film 33 is formed and the other surface 32b opposite to the one surface 32a are formed into curved surfaces.

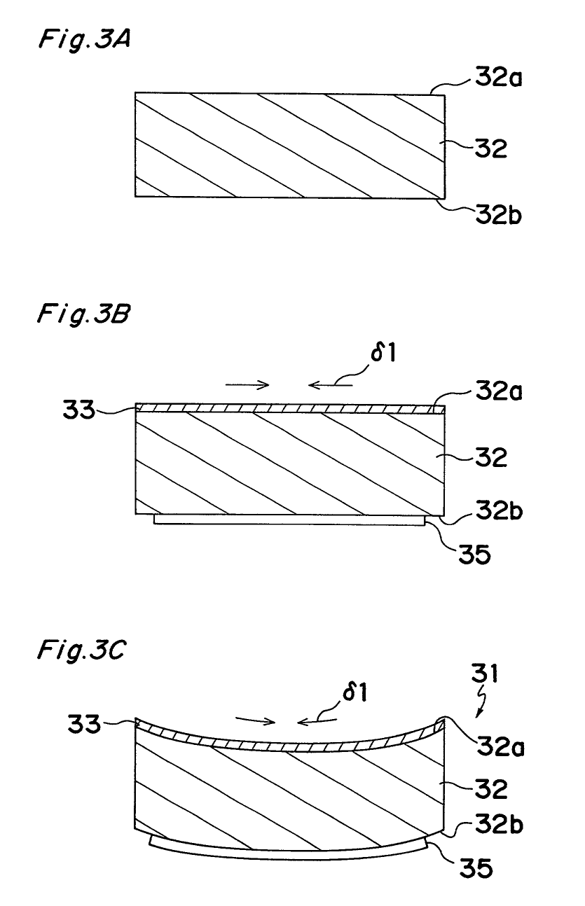

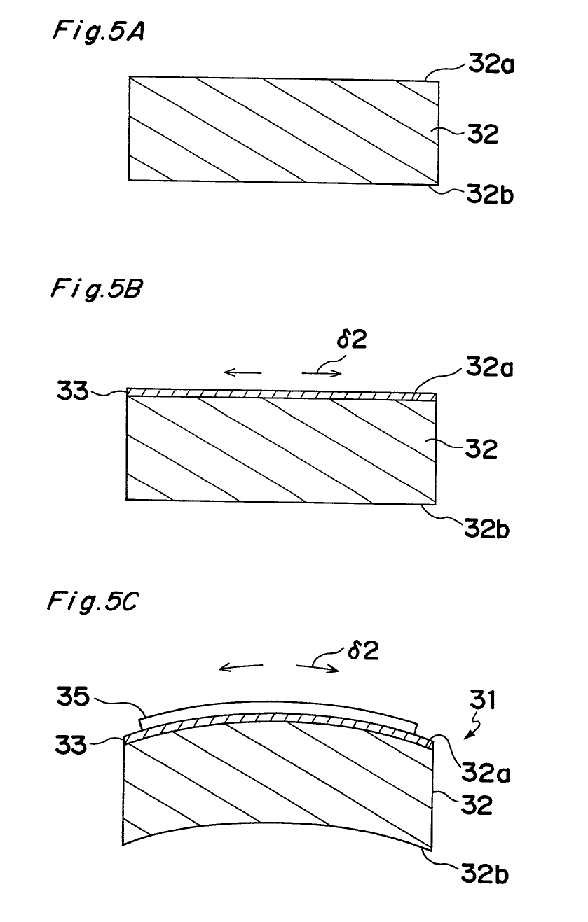

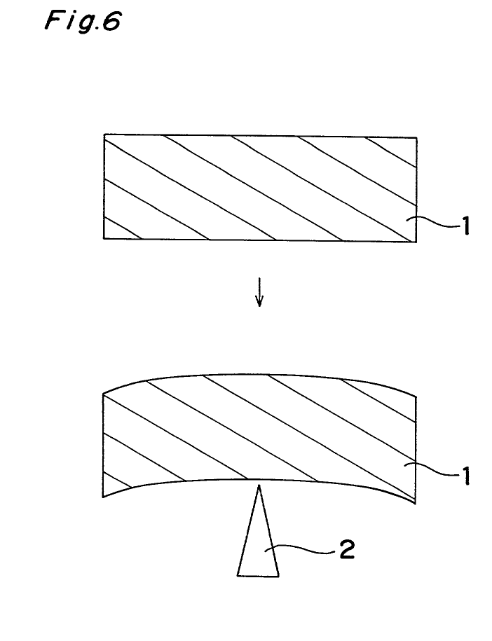

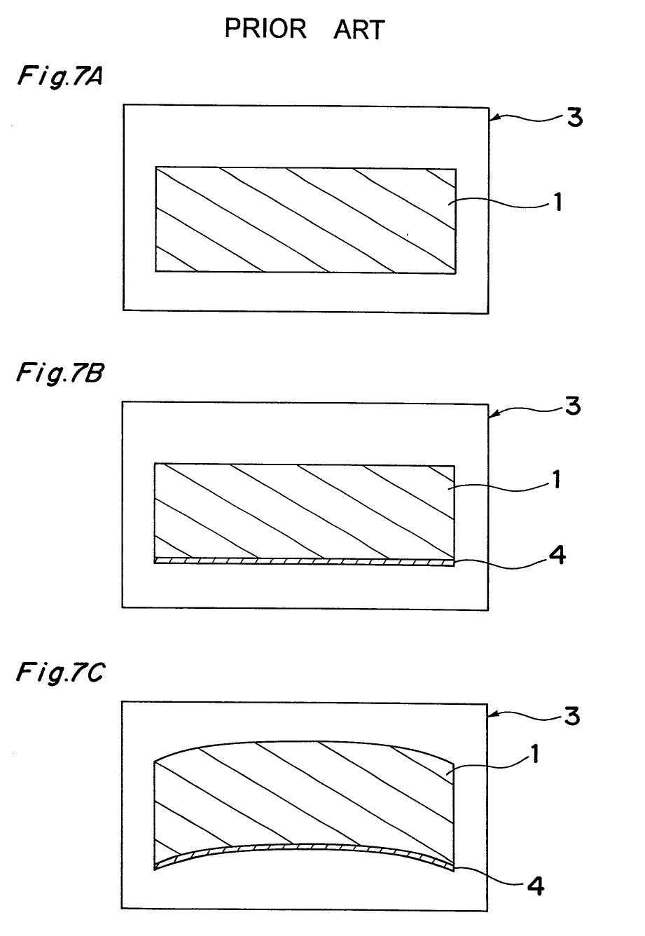

In the embodiment shown in FIGS. 3B and 3C, the inner stress δ1 is a tensile stress. The inner stress δ1 causes a deformation force acting on the magnetic head substrate 32 so that the other surface 32b opposite to the thin film 33 is formed into a convex curved surface. Further, the other surface 32b, which is the convex curved surface, constitutes a head surface on which air bearing surfaces 35 are formed. On the other hand, in the embodiment shown in FIGS. 5B and 5C, the inner stress δ2 is a compression stress. The inner stress δ2 causes a deformation force acting on the magnetic head substrate 32 so that the one surface 32a with the thin film 33 is formed into a convex curved surface. Further, the one surface 32a, which is the convex curved surface 32a, constitutes a head surface on which air bearing surfaces 35 are formed.

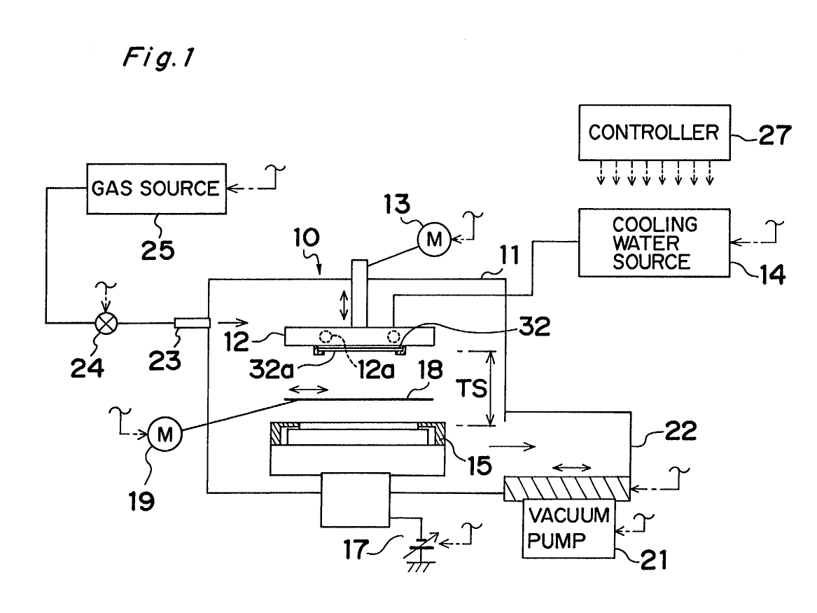

FIG. 1 shows an example of a sputtering apparatus 10 used for manufacturing the magnetic head 31.

In an evacuated chamber 11, a substrate holder 12 is arranged. This substrate holder 12 holds the magnetic head substrate 32 in the manner that deformation of the magnetic head substrate 32 due to the inner stresses δ1 and δ2 is tolerated. Further, the substrate holder 12 is moved up and down by a driving unit 13.

The substrate holder 12 is formed with a cooling water channel 12. In the cooling water channel 12, cooling water supplied from a cooling water source 14 is circulated, thereby the magnetic head substrate 32 are cooled during the sputtering. The substrate holder 12 has large heat capacity by setting its volume enough large.

In the evacuated chamber 11, a target 15 is arranged so as to be opposed to the substrate holder 12. The target 15 is electrically connected with a power supply 17. Although a direct current power supply is used as the power supply 17 in this embodiment, a high-frequency power supply may be used in case that the target 15 is composed of an electrical insulator. Arranged between the substrate holder 12 and the target 15 is a shutter 18. The shutter 18 is opened and closed by a driving unit 19.

A vacuum pump 21 for discharging is connected with an interior of the evacuated chamber 11 via a valve 22. On the other hand, a gas inlet 23 formed on the evacuated chamber 11 is connected with a gas source 25 via a valve 24. Process gas is supplied from the gas source 25 to the interior of the evacuated chamber 11 via the valve 24.

A controller 27 controls the driving unit 13 for the substrate holder 12, cooling water source 14, power supply 17, driving unit 19 for the shutter 18, valves 22 and 24, vacuum pump 21, and gas source 25.

A method for manufacturing the magnetic head will be described with taking the magnetic head 31 shown in FIGS. 2D and 3C as an example.

The magnetic head substrate 32 of bar-like shape shown in FIGS. 2A and 2B is attached to the substrate holder 12 so that the one surface 32a is directed downwardly. On the other surface 32b of the magnetic head substrate 32, the air bearing surfaces 35 are formed beforehand.

Then, for the purpose of coordinating precision of the film thickness distribution, the substrate holder 12 is moved upwardly and downwardly by the driving unit 13 so as to adjust a distance TS between the magnetic head substrate 32 and the target 15 according to arrangement area of the magnetic head substrate 32.

After that, the interior of the evacuated chamber 11 is discharged until the pressure in the evacuated chamber 11 reaches a predetermined pressure (initial pressure). In this embodiment, the discharge of the evacuated chamber 11 is continued until the initial pressure reaches approximately 10⁻³ Pa. Further, a process gas such as argon (Ar) gas is introduced from the gas source 25 to the interior of the evacuated chamber 11 via the gas inlet 23. In these processes, a flow rate of the process gas introduced from the gas inlet 23 and a flow rate of discharging by the vacuum pump 21 are set same value, thereby a pressure in the interior of the evacuated chamber 11 is maintained constant. This constant pressure is a pressure during formation of the thin film.

Next, with keeping the shutter 18 closed, a voltage from the power source 17 is applied to the target 15 so as to generate plasma discharge. In order to clean up substances such as oxide on the surface of the target 15, the stable plasma discharge is maintained for a few minutes. After that, the shutter 18 is opened, resulting in that a sputtering film or thin film 33 is formed on the one surface 32a of the magnetic head substrate 32 as shown in FIGS. 2B and 3B. A thickness of the thin film 33 is set to not more than 1 μm. As shown in FIGS. 2C and 3C, due to the inner stress δ1, the magnetic head substrate 32 is curved and the other surface 32b opposite to the thin film 33 is formed into a convex curved surface.

Long duration of forming the thin film by sputtering causes a rise in temperature of the magnetic head substrate 32 due to incident of energy from sputter particles to the magnetic head substrate 32. However, in this embodiment, the cooling of the substrate holder 12 by the cooling water and the large heat capacity of the substrate holder 12 reduces the rise in temperature of the magnetic head substrate 32. Although effect of the cooling the magnetic head substrate 32 depends on the material thereof, cooling the magnetic head substrate 32 to the temperature of not more than 50° C. prevents the properties of the devices 34A and 34B from being damaged due to the heat even if these devices 34A and 34B are sensitive.

After accomplishment of the formation of the thin film 33, the magnetic head substrate 32 is taken out from the evacuated chamber 11. Then, the magnetic substrate 32 is cut to separate into respective magnetic heads 31 as shown by lines C in FIG. 2D. For instance, this cutting of the magnetic substrate 32 is executed by using a dicing saw.

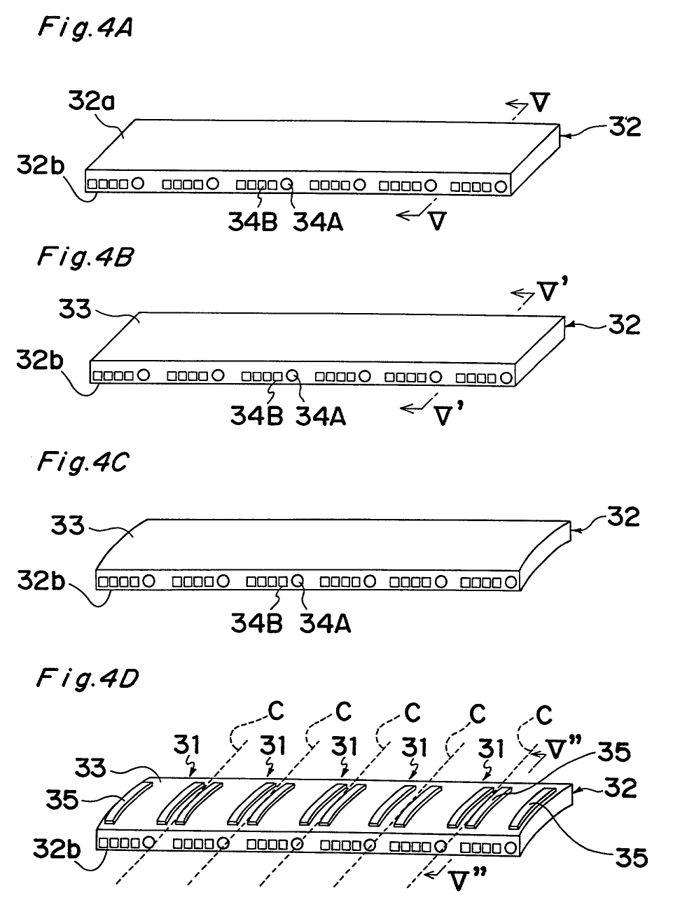

The magnetic head 31 shown in FIGS. 4D and 5C can be manufactured by same method as above-mentioned method for manufacturing the magnetic head 31 shown in FIGS. 2D and 3C excepting that the air bearing surfaces 35 are formed after accomplishment of the formation of the thin film (refer to FIGS. 4A through 4D and FIGS. 5A through 5C).

As mentioned above, whether the inner stress is the tensile stress or the compression stress causes difference on the direction of the curve of the magnetic head substrate 32, namely which of the one surface 32a and the other surface 32b becomes the convex curved surface. In addition, the greater inner stress results in that degree of the curve of the magnetic head substrate 32, namely the curvatures of the one surface 32a and the other surface 32b, increases. Accordingly, by controlling the pressure during formation of the thin film, the initial pressure, or the voltage applied to the target 15, both the direction of the curve and the curvature of the magnetic head substrate 32 can be adjusted.

First, the adjustment by the pressure during formation of the thin film will be described.

The pressure during formation of the thin film can be adjusted by using the vacuum pump 21 and/or the gas source 25. Specifically, the pressure during formation of the thin film is increased when the flow rate of the process gas supplied from the gas source 25 is increased with respect to the discharge flow rate of the vacuum pump 21. Contrary, the pressure during formation of the thin film is decreased when the flow rate of the process gas is decreased with respect to the discharge flow rate.

With increase of the pressure during formation of the thin film, energy of respective target particles from the target 15 to one surface 32a of the magnetic head substrate 32 is decreased. Thus, when the pressure during formation of the thin film is high, degree of the density of the thin film 33 is low and attractive forces between atoms constituting the thin film 33 have large influence on the curvature of the magnetic head substrate 32. This results in that the inner stress of the thin film 33 is tensile stress δ1 (refer to FIG. 3C) and the other surface 32b opposite to the thin film 33 becomes the convex curved surface.

On the other hand, with decrease of the pressure during formation of the thin film, the energy of respective target particles from the target 15 to one surface 32a of the magnet head substrate 32 is increased. Thus, the when the pressure during formation of the thin film is low, degree of the density of the thin film 33 is high and repulsive forces between the atoms constituting the thin film 33 have large influence on the curvature of the magnetic head substrate 32. This results in that the inner stress of the thin film 33 is compression stress δ2 (refer to FIG. 5C) and the one surface 32a on which the thin film 33 is formed becomes the convex curved surface.

In other wards, by setting the pressure during the formation of the thin film 33 higher than a predetermined pressure, the other surface 32b opposite to the one surface 32a on which the thin film 33 is formed becomes a convex curved surface. Contrary, by setting the pressure during the formation of the thin film 33 lower than the predetermined pressure, the one surface 32a on which the thin film 33 is formed becomes a convex curved surface.

Next, the adjustment by the initial pressure will be described.

Before starting the discharging by using the vacuum pump 21, moisture is adhered on inner wall surfaces of the evacuated chamber 11 and the magnetic head substrate 32. With decrease of the initial pressure, residual volume of the moisture is decreased at the start of sputtering. Contrary, with increase of the initial pressure, the residual volume of the moisture is increased at the start of sputtering.

Accordingly, when the initial pressure is high, the residual moisture in the evacuated chamber 11 adhesives to the target particles, generating flocculation. Due to this flocculation, degree of the density of the thin film 33 is decreased. This results in that the inner stress of the thin film 33 is tensile stress δ1 (refer to FIG. 3C) and the one surface 32a on which the thin film 33 is formed becomes the convex curved surface.

On the other hand, when the initial pressure is low, the flocculation is not generated and thus the degree of the density of the thin film 33 is increased. This results in that the inner stress of the thin film 33 is compression stress δ2 (refer to FIG. 5C) and the other surface 32b opposite to the thin film 33 becomes the convex curved surface.

In other wards, by setting the initial pressure higher than a predetermined pressure, the other surface 32b opposite to the one surface 32a on which the thin film 33 is formed becomes a convex curved surface. Contrary, by setting the initial pressure lower than the predetermined pressure, the one surface 32a on which the thin film 33 is formed becomes a convex curved surface.

Next, the adjustment by the voltage applied to the target will be described.

With increase of the voltage applied to the target 15, energy of respective sputtering particles toward the magnetic head substrate 32 is increased. Thus, when the applied voltage is high, the degree of the density of the thin film 33 is high. This results in that the inner stress of the thin film 33 is compression stress δ2 (refer to FIG. 5C) and the one surface 32a on which the thin film 33 is formed becomes the convex curved surface.

On the other hand, when the applied voltage is low, the degree of the density of the thin film 33 is low. This results in that the inner stress of the thin film 33 is the tensile stress δ1 (refer to FIG. 3C) and the other surface 32b opposite to the thin film 33 becomes the convex curved surface.

In other wards, by setting the voltage higher than a predetermined voltage, the one surface 32a on which the thin film 33 is formed becomes a convex curved surface. Contrary, by setting the voltage lower than a predetermined voltage, the other surface 32b opposite to the one surface 32a on which the thin film 33 is formed becomes a convex curved surface.

Atomic weight of the material constituting the target 15 is preferably not less than 40 and not more than 240. This is because that if the atomic weight is less than 40, it is difficult to form the thin film with the inner stress needed for bending the magnet head substrate due to small energy of the sputtering particles. On the other hand, if the atomic weight is not less than 40, it is possible to form the thin film with the inner stress needed for bending the magnet head substrate due to large energy of the sputtering particles. Further, in this case, the direction of curve and the curvature of the magnetic substrate can be adjusted by the pressure during the formation of the thin film, the initial pressure, and the applied voltage. Further, a maximum atomic weight of a metal that can be used as target 15 is approximately 240.

According to experiments conducted by the present inventor, in case that the structure body is an Al₂O₃-TiC substrate, the material of the target or thin film is tantalum or Chromium, and the Al₂O₃-TiC substrate is cooled within temperature range of 20 through 50° C., the Al₂O₃-TiC substrate can be curved so that it has curved surfaces with any given curvature by adjusting the pressure during the formation of the thin film within the range of 0.5 Pa through 5.0 Pa.

Although above-mentioned embodiment is described with taking the magnetic head as an example, the present invention can adopt to devices such as electronic devices other than the magnetic head, optical devices, and precision parts. Further, the structure body may be composed of materials such as ceramic materials other than the Al₂O₃-TiC, glasses, resins, and metals. Furthermore, the thin film may be composed of materials such as zirconium (Zr), niobium (Nb), tungsten (W), molybdenum (Mo), titanium (Ti), nickel (Ni), vanadium (V), iron (Fe), silver (Ag), copper (Cu), and gold (Au).

Although the present invention has been fully described by way of the examples with reference to the accompanying drawings, it is to be noted here that various changes and modifications will be apparent to those who skilled in the art. Therefore, unless such changes and modifications otherwise depart from the spirit and scope of the present invention, they should be construed as being therein.

What is claimed is:

1. A method for manufacturing a structure with curved surfaces comprising:
providing a structure body;
forming a thin film on one surface of the structure body by sputtering so that the structure body is curved by an inner stress generated in the thin film, thereby the one surface of the structure body and the other surface of the structure body are formed into the curved surfaces.

2. A method according to claim 1, wherein the thin film is composed of a material having an atomic weight of not less than 40 and not more than 240.

3. A method according to claim 1, wherein curvatures of the surfaces are adjusted by a pressure during the formation of the thin film by sputtering.

4. A method according to claim 3, wherein by setting the pressure higher than a predetermined pressure, the other surface opposite to the one surface on which the thin film is formed becomes a convex curved surface; and
wherein by setting the pressure lower than the predetermined pressure, the one surface on which the thin film is formed becomes a convex curved surface.

5. A method according to claim 1, wherein the formation of the thin film by sputtering is executed in an evacuated chamber, and
wherein curvatures of the surfaces are adjusted by an initial pressure in the evacuated chamber before the formation of the thin film.

6. A method according to claim 5, wherein by setting the initial pressure higher than a predetermined pressure, the other surface opposite to the one surface on which the thin film is formed becomes a convex curved surface; and
wherein by setting the initial pressure lower than the predetermined pressure, the one surface on which the thin film is formed becomes a convex curved surface.

7. A method according to claim 1, wherein the formation of the thin film by sputtering is executed by appliance of a voltage to a target opposite to the structure body, and wherein curvatures of the surfaces are adjusted by the voltage applied to the target.

8. A method according to the claim 7, wherein by setting the voltage higher than a predetermined voltage, the one surface on which the thin film is formed becomes a convex curved surface; and
wherein by setting the voltage lower than a predetermined voltage, the other surface opposite to the one surface on which the thin film is formed becomes a convex curved surface.

9. A method according to claim 1, wherein the structure body is cooled during the formation of the thin film.

10. A method according to claim 1, wherein the structure body is an Al₂O₃-TiC substrate, a temperature of the structure body during sputtering is not less than 20° C. and not more than 50° C., a pressure in an evacuated chamber during sputtering is not less than 0.5 Pa and not more than 5.0 Pa, and the thin film is composed of tantalum or Chromium.

11. A method for manufacturing a magnetic head, comprising:
providing a magnetic head substrate with a single or a plurality of built-in devices; and
forming a thin film on one surface of the magnetic head substrate by sputtering so that the magnetic head substrate is curved by an inner stress generated in the thin film, thereby the one surface and the other surface of the magnetic head substrate are formed into curved surfaces, convex one of which acts as a head surface.

12. A method according to claim 11 further comprising, cutting the magnetic head substrate to separate into a plurality of magnetic heads after the formation of the thin film on the one side of the magnetic head substrate.

13. A structure with curved surfaces comprising:
a structure body; and
a thin film formed on one surface of the structure body by sputtering,
wherein the structure body is curved by an inner stress of the thin film, thereby the one surface of the structure body and the other surface of the structure body opposite to the one surface are formed into the curved surfaces.

14. A structure according to claim 13, wherein the thin film is composed of a material having an atomic weight of not less than 40 and not more than 240.

15. A structure according to claim 13, wherein the structure body is an Al₂O₃-TiC substrate and the thin film is composed of tantalum or chromium.

16. A magnetic head comprising:
a magnetic head substrate with a single or a plurality of built-in devices; and
a thin film formed on one surface of the magnetic head substrate by sputtering,
wherein the magnetic head substrate is curved by an inner stress of the thin film, thereby the one surface of the magnetic head substrate or the other surface of the magnetic head substrate opposite to the one surface is formed into a convex curved surface acts as a head surface.
